(19) United States
(12) Patent Application Publication
(10) Pub. No.: US 2003/0227381 A1
(43) Pub. Date: Dec. 11, 2003

(54) Alarm notification device

(76) Inventor: Hilary A. Best JR., Forest Hills, NY (US)

Correspondence Address: Mr. Hilary A. Best, Jr., Post Office Box 751072, Forest Hills, NY, 11375, US

(21) Appl. No.: 10/383,379

(22) Filed: Mar. 7, 2003

Related U.S. Application Data
(60) Provisional application No. 60/362,361, filed on Mar. 7, 2002.

(51) Int. Cl. G08B 1/00

(52) U.S. Cl. 340/531; 340/541; 340/539.1

(57) ABSTRACT

Security alarm Transmitting Device comprising the ability to receive and process input from security alarm sensors, including photographic imaging devices, and immediately transmit a wireless telecommunications notification to the user at a preselected destination point (telephone, cellular telephone, picture telephone, numeric or alphanumeric pager or text message device) via available cellular, satellite or internet telecommunications systems, including internet telephone calls, for the purpose of providing to the user direct notification of a security breach.

Provisional Patent Application filed Mar. 7, 2002 (Serial No. 60-362361)

No Federally Sponsored Research or Development

### BACKGROUND OF THE INVENTION

The present invention relates to a telecommunications transmitting device to be used with vehicle and home security sensor mechanisms, including photo sensors, with the ability to transmit notification concerning breaches of security to preselected telephone, cellular telephone, or picture telephone numbers, numeric or alphanumeric pager numbers, or internet communications numbers, such as PC telephone calls, etc.

Currently (as of the Provisional Patent Application filing dated of Mar. 7, 2002), vehicle security alarm systems are limited in their ability to immediately notify owners of security breaches. Generally, such alarms are able to provide immediate notification only in the form of noise devices, such as horns or sirens, which usually end up being beyond the hearing distance of the owner when triggered. Further, if an alarm is triggered accidentally, and the owner is within hearing and/or visual distance of the vehicle, such as from a window or terrace view, the alarm cannot be reset or disabled by the alarm's remote control if it is beyond the device's short operating range. The owner is thus troubled (usually by having to get dressed to go outside, etc.) to move within the direct operational range of the remote control, usually about 15 to 20 feet.

Additionally, vehicle theft deterrent systems, like Lo/Jack, only provide for the recovery of stolen vehicles after they have been reported missing to the police department. There is no provision for immediate notification to the vehicle's owner of the initial security breach (i.e., the unauthorized entry of the vehicle), thereby enabling the possibility of preventing the theft before it occurs. Only two recent invention devices endeavored to provide immediate notification to the vehicle owner of security breaches: one in the form of a radio transmitter installed in the vehicle that would signal a pager like device carried by the individual, but which lacked long range ability and was impeded by building structures, rendering it relatively ineffective as a reliable means of security breach notification; the other in the form of a cellular phone that could be used as a security alarm transmitter, but which presented the inconvenience of having to forego use of the cell phone while it is being used as an alarm notification device, and requiring use of an additional cell phone if such was the preferred means of notification. Indeed, how would one be notified by their cell phone of a security breach when that very phone is being used as the transmitter at the location being monitored? A person would have to carry two (2) cell phones, which people in general would simply find cumbersome and undesirable. Regarding home security systems like ADT and Slomin Shield, the notification alert is hardwired to a monitoring center, but notification of a security breach is generally sent only to law enforcement or emergency personnel for investigation, not to the owner for individual monitoring and immediate intervention on their part.

The present invention seeks to overcome the shortcomings of current home and vehicle security alarm systems, by seeking to provide immediate and direct notification to the owner of a security breach of any property (including, but not limited to boats, buses, planes, trucks, hotel rooms, etc.) via telecommunications services, so that the property owner can take immediate steps to verify the security breach and, by either personal intervention or by alerting authorities, prevent theft or damage to the property that the security alarm system is intended to protect.

Further, while the generally intended use of this invention is for installation in homes, cars, trucks, buses, boats and airplanes, etc., it is also intended for use at any location (e.g., hotel rooms, construction sites, etc.). The user need only connect the transmitter to a particular security sensor device (perimeter, motion, shock, etc.), enter the number to be called for notification and the code selecting the type of message to be transmitted (numeric, alphanumeric, synthesized voice or text message, though it is expected that the notification device will have the ability to automatically determine the type of message to deliver by analyzing the telecommunications channel used for the call and capabilities of the message receiving device, thereby foregoing the need for a code selection), and the Transmitter's microprocessor does the rest.

### SUMMARY OF INVENTION

The Transmitting Device comprises a microprocessor, which is programmed with the ability to transmit notification of a triggered security alarm alert via telecommunications systems to numeric, alphanumeric, voice or text message phones and devices, including picture phones, and doing so requires only connection to an appropriate power supply, and the appropriate access numbers and codes inputted to the transmitter's memory bank, usually by way of an electronic SIM (System Information Management) card. Using information from the entered data, the Transmitting Device is able to determine the number to be called, and whether the notification shall be in the form of a numeric, alphanumeric, text or synthesized voice message, or photographic image for viewing on a picture phone, and has the ability to transmit the same. The numeric message will be in the form of a Caller ID, while the alphanumeric, text and synthesized voice notification messages generated by the transmitter will be in short form, simply to notify the recipient that the alarm has been triggered. If the device receiving the notification is a picture phone and a photo imaging device is connected to the alarm's system, the notification will be accompanied by a photographic image taken at the time the sensor was triggered resulting in the notification.

One variation and sister model enables the same telecommunications channels used to transmit an alarm notification message to also transmit commands to the transmitter to change the notification number and activate, deactivate or reset the Transmitting Device as needed or desired by the user. It is expected that the user will select a telecommunications service provider, and that the service access information will be inputted to the Transmitting Device by use of a removable electronic information (SIM) card and activated for use in the same manner as a cellular telephone or numeric or alphanumeric pager is programmed and activated for use by the general public, except that once activated, the desired notification number to be contacted can be arbitrarily changed, using an optional keypad, or by wireless telecommunications transmissions to the Transmitting Device. Each Transmitting Device, having individual identity codes, will enable any telecommunications service provider's system to identify and communicate with the selected Transmitting Device in the same manner as it would with any cellular or satellite communications device, and is not limited to any one cellular and satellite frequency.

### BRIEF DESCRIPTION OF THE SEVERAL VIEWS OF THE DRAWINGS

FIG. 1 shows a schematic of the Basic Model for Home and Vehicle use, consisting of the Transmitting Device, which is small in size, about 3″ by 5,″ and about 1″ to 2″ in depth, with an antenna and terminals for electronic sensor connections, including photographic imaging for the transmission of photographic images to a picture telephone or other image receiving device, and terminals for power supply.

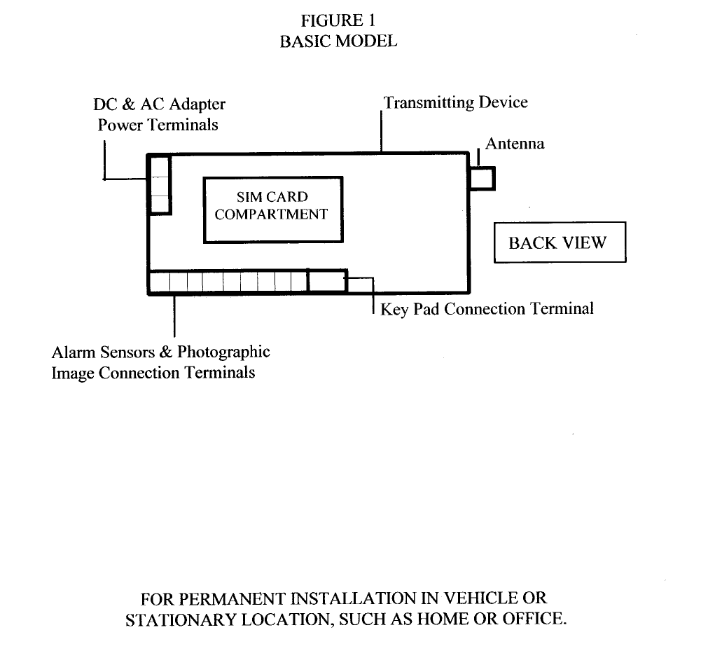

FIG. 2 shows the Deluxe Model for Home and Vehicle use, consisting of the same features as the Basic Model, but also provides a numeric key pad which connects to the Transmitting Device by a 12 foot wire which permits the user to conceal the Transmitting Device and arbitrarily select the number to which the triggered alarm notification is to be sent (it is expected that the keypad will ultimately be able to communicate wirelessly to the Transmitting Device, which a direct operating range of 15 to 20 feet, to permit total concealment of the Transmitting Device).

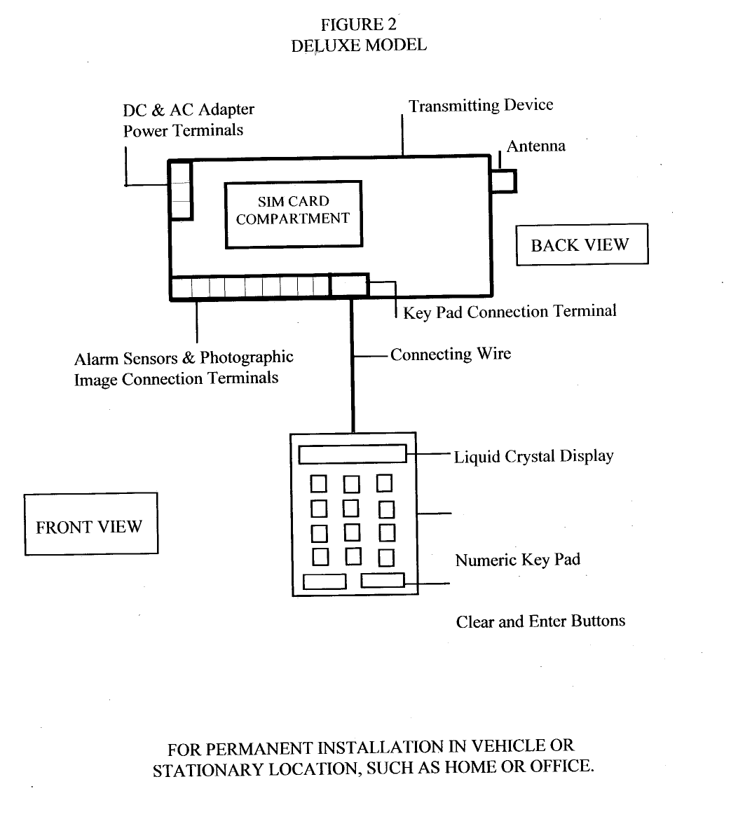

FIG. 3 shows the Portable Model for temporary Location and Vehicle use, such as in hotel rooms and rental cars, where the desired monitoring is temporary and negates permanent instillation, but the user wishes to detect intruders, as the Portable Model provides a built in peripheral motion detection sensor.

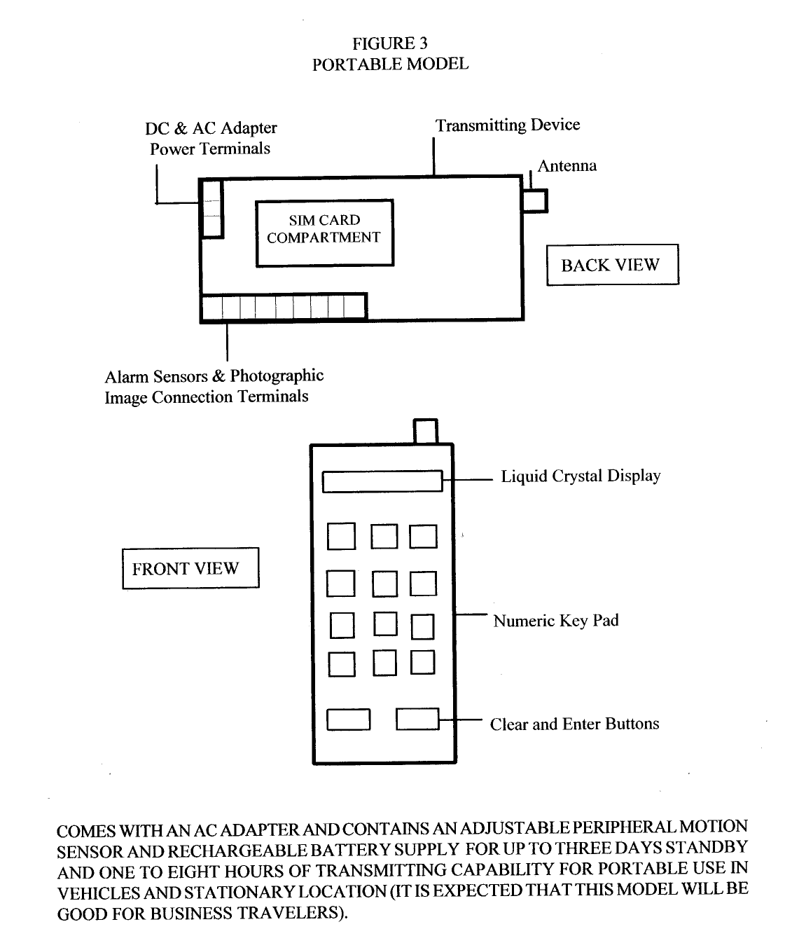

All three models can be ordered with the optional remote control feature which permits the user to telephone commands to the Transmitting Device to have it deactivate, activate, or reset as desired by the user.

### DETAILED DESCRIPTION OF THE INVENTION

Rectangular in shape, with antenna and connection terminals for sensor devices, and a backup memory linked to an internal rechargeable power supply. The basic version is a single black cased unit with a compartment secured by a removable access cover, in which compartment is one or more telecommunications (SIM) card slots. The telecommunications card that fits into the slot contains the access codes and protocols providing access to the network of the telecommunications service provider (usually a subscription service provider). The deluxe version comes with a keypad featuring a Liquid Crystal Display (LCD), which connects to the unit by an extended wire (or wirelessly with an operating range of 15 to 20 feet), permitting concealment of the transmitting device and enabling the user to arbitrarily change the number to which the breach of security alarm notification will be sent.

Still yet another version will, in addition to the preceding features, permit wireless telecommunications transmissions to the unit, enabling the user to activate, deactivate and reset the entire security alarm system, so that if a car's horn is blasting or its siren blaring in the middle of the night, but indications are that they were triggered accidentally, the owner can reset or deactivate the alarm without having to leave the comfort of bed or the indoors to go outside. In the event that the sensor device is triggered by an alarm event, the unit will immediately initiate a telecommunications call to the selected notification number and will repeat the notification process until the call is completed and the message delivered. If the channel permits, the unit will generate a synthesized voice message or text message, or numeric (Caller ID) or alphanumeric message indicating that the alarm has been triggered. If a photographic imaging device is also connected to the Transmitting Device, a photographic image will accompany the transmission for viewing on a picture phone. The unit will then reset and repeat the alarm notification transmission every 60 seconds that a triggered alarm event remains in effect.

Still yet another version of the Transmitting Device is a portable unit comprising a peripheral motion sensor, numeric keypad and liquid crystal display, with terminals for connecting additional sensor devices, including photographic imaging devices, permitting the user to arbitrarily select the telecommunications number to notify and/or transmit photographic images in the event that the alarm's sensor is triggered.

What I claim as my invention is:

1. A Telecommunications Device comprising:
1. means for receiving and processing electronic information from any kind of vehicle or home security alarm sensor device, such as motion, shock or circuit interruption sensor devices, or photographic image devices used for capturing an image when triggered by an alarm event;
2. means for providing, via available telephone, cellular telephone, picture telephone or numeric or alphanumeric pager or text messaging system or device, transmitted via telecommunications channels, including internet telephone calls, immediate notification of a triggered alarm event;
3. means, either directly using a numeric key pad, or by coded wireless transmissions to the Transmitting Device via available telecommunications channels, for activating, deactivating and resetting the Transmitting Device, and changing the number to be called when providing immediate notification to the user of a triggered alarm event;
4. means to monitor full featured vehicle and home security alarm systems and initiate telecommunication notifications to telephones, cellular phones, picture phones, numeric and alphanumeric and text message devices, including internet telephone calls (requires a direct internet connection) resulting from triggered alarm sensor detections, and is powered by car voltage electricity, or an AC adapter for non vehicle use, such as for home or office security.
5. triggered alarm event means a predetermined occurrence resulting from an alarm system sensor or device intended to provide security for the monitored property or location, and that a breach of that security has occurred;
6. predetermined occurrence means a wireless telecommunications transmission consisting of an alarm notification message in the form of a numeric (Caller ID), alphanumeric or text or synthesized voice message notification, which can be accompanied by a photographic image for a picture phone;
7. wireless transmission means initiation and completion of a wireless telecommunications transmission, including photo imaging transmissions, via available telephone, cellular telephone, picture telephone, numeric or alphanumeric pager or text message systems, using cellular, satellite or internet telecommunications services, such as Internet Telephone Calls, after which the transmitting device automatically resets to repeat the programmed function. In the event that the transmission is not completed during the initial attempt, the Transmitting Device will repeat the function until completed.
8. photographic imaging transmission means an alarm system comprising a photographic imaging device designed to capture a photographic image when triggered by a sensor device, and the transmission of the captured image via telecommunications channels to a picture phone or other image receiving device.
